(19) United States
(12) Patent Application Publication
(10) Pub. No.: US 2025/0208943 A1
(43) Pub. Date: Jun. 26, 2025

(54) System And Method Of Instability Analysis And Feature Adaptation

(71) Applicant: TiVo Platform Technologies LLC, San Jose, CA (US)

(72) Inventors: Kush Gupta, Bangalore (IN); Ashish Gupta, Bangalore (IN); Senthil Kumar Karuppasamy, Bangalore (IN); Yashika Varshney, Bangalore (IN); Vaibhav Gupta, Bangalore (IN)

(21) Appl. No.: 18/390,868

(22) Filed: Dec. 20, 2023

(51) Int. Cl. G06F 11/07; G06F 11/36

(52) U.S. Cl. CPC G06F 11/079; G06F 11/0766; G06F 11/36

(57) ABSTRACT

Generally disclosed herein is a mechanism to address problems within entities that typically result in failure to playback media content. The solution uses an intelligent system that identifies features or assets causing the problems and takes the corresponding action to work around the features or assets. For example, as failures occur, problematic data may be recorded, such as into a centralized server. The recorded problematic data may be used as training data for a machine learning algorithm that analyzes the recorded problem data and identifies errors in the recorded problematic data causing the failure. The machine learning algorithm may further receive as input current data related to media content to be played and identify current errors in the current data based on the identified errors in the recorded problematic data.

### BACKGROUND

Modern electronic devices, such as smartphones, tablets, portable game consoles, music players, and household media devices, are bundled with a variety of features. The development of such devices involves various media entities, such as content providers, metadata providers, and supportive modules. If an issue arises within any of these entities, it can lead to failures or crashes, thereby significantly impacting user experiences. Addressing each problem within each of the entities may require complex and time-consuming processes. Thus, a considerable number of users can be affected by such issues until they are fixed by the respective entities.

### BRIEF SUMMARY

Generally disclosed herein is a mechanism to address problems within entities that typically result in failure to playback media content. The solution uses an intelligent system that identifies features or assets causing the problems and takes the corresponding action to work around the features or assets. For example, as failures occur, problematic data may be recorded, such as into a centralized server. The recorded problematic data may be used as training data for a machine learning algorithm that analyzes the recorded problem data and identifies errors in the recorded problematic data causing the failure. The machine learning algorithm may further receive as input current data related to media content to be played and identify current errors in the current data based on the identified errors in the recorded problematic data. In other words, a first data set may include recorded historical problematic data, which may be used to identify where errors exist in a second current data set. Once the issues in the second current data set are identified, such issues can be addressed such that playback of the media content can be performed without failure. According to some examples, addressing the issue may include removing problematic data from the second current data set. Removing the problematic data may correspond to the removal of one or more features or assets related to the media content, such as metadata, closed captioning, translation, or any of a variety of other features or assets. In some examples, removing the problematic data may correspond to the removal of one piece of media content, requiring a viewer to instead select a different piece of media content on the same or different viewing platform. In other examples, the problematic data may be modified, and the second current dataset may be updated with the modified problematic data.

An aspect of the disclosure provides a method for adaptive media content management. The method includes receiving, by one or more processors, error logs from a plurality of user devices, wherein the error logs were generated in relation to a playback of a first set of media content; analyzing, by the one or more processors executing an artificial intelligence model, the received error logs; determining, by the one or more processors, one or more patterns of problematic data from the error logs; determining potential problems associated with a second set of media content based on the one or more patterns; identifying assets or features corresponding to the potential problems associated with the second set of media content; and removing the assets or features corresponding to the predicted potential problems from the media content.

In an example, the method further includes modifying the assets or features corresponding to the predicted potential problems.

In another example, the method further includes determining one or more stable patterns of data within the assets or features.

In yet another example, the method further includes increasing a priority of the media content containing the stable data using a media content recommendation system.

In yet another example, the method further includes notifying viewers of the second set of media content of the predicted potential problems.

Another aspect of the disclosure provides a system for adaptive media content management, the system includes memory and one or more processors configured to receive error logs from a plurality of user devices, wherein the error logs were generated in relation to a playback of a first set of media content; analyze, using an artificial intelligence model, the received error logs; determine one or more patterns of problematic data from the error logs; determine potential problems associated with a second set of media content based on the one or more patterns; identify assets or features corresponding to the potential problems associated with the second set of media content; and remove the assets or features corresponding to the predicted potential problems from the media content.

In an example, the one or more processors are further configured to modify the assets or features corresponding to the predicted potential problems.

In another example, the one or more processors are further configured to determine one or more stable patterns of data within the assets or features.

In yet another example, the one or more processors are further configured to increase a priority of the media content containing the stable data using a media content recommendation system.

In yet another example, the one or more processors are further configured to notify viewers of the second set of media content of the predicted potential problems.

Yet another aspect of the disclosure provides a non-transitory computer-readable medium storing instructions executable by one or more processors for performing a method of adaptive media content management. The method includes: receiving error logs from a plurality of user devices, wherein the error logs were generated in relation to a playback of a first set of media content; analyzing, using an artificial intelligence model, the received error logs; determining one or more patterns of problematic data from the error logs; determining potential problems associated with a second set of media content based on the one or more patterns; identifying assets or features corresponding to the potential problems associated with the second set of media content; and removing the assets or features corresponding to the predicted potential problems from the media content.

In an example, the method further includes modifying the assets or features corresponding to the predicted potential problems.

In another example, the method further includes determining one or more stable patterns of data within the assets or features.

In yet another example, the method further includes increasing a priority of the media content containing the stable data using a media content recommendation system.

In yet another example, the method further includes notifying viewers of the second set of media content of the predicted potential problems.

The above and other aspects of the disclosure can include one or more of the following features. In some examples, aspects of the disclosure provide for all of the following features in combination.

In an example, the error logs are generated when crashes, instability, or malfunctioning occurs.

In another example, the error logs include information related to a content identifier of the media content and a timestamp recorded when one or more errors occurred.

### BRIEF DESCRIPTION OF THE DRAWINGS

FIG. 1 depicts a block diagram illustrating a faulty asset removal on the server side according to aspects of the disclosure.

FIG. 2 depicts a block diagram illustrating a faulty asset removal on the client side according to aspects of the disclosure.

FIG. 3 depicts a block diagram illustrating an example intelligent asset management system according to aspects of the disclosure.

FIG. 4 depicts a flow diagram illustrating an example faulty asset removal process according to aspects of the disclosure.

### DETAILED DESCRIPTION

The present disclosure describes a system and method for identifying faulty features or assets that would otherwise result in failure of playback of media content, and removing or otherwise addressing the identified faulty features such that the media content can be played without failure. According to some examples, the method may include reports from client devices to determine which media assets are causing instability, crashes, or malfunctioning while media content is being played. The media features, such as closed captioning, Bluetooth compatibility, language translation, resolution level selection, etc. may not function appropriately and interrupt playback of the media content. The logs may be analyzed using an artificial intelligence (AI) system, such as machine learning. The media features or assets causing the instability, crashes, or malfunctioning can be removed from a server database or notified to the client devices.

For the purpose of the present disclosure, media entities may refer to media content providers including television programming service providers and online streaming service providers. Media content may refer to any type of sound, images, videos or similar matter distributed via media platforms such as streaming, social media, websites, mobile applications, television and radio, etc. Media content may include television series, movies, podcasts, music videos, digital newspapers, etc. Media assets may refer to data or files in a variety of formats for storing the media content. For example, JPEG, PNG, GIF, and other image file formats may be used for photographs and graphics. MP4, MOV, AVI, and other file formats may be used for videos. MP3, WAV, and other audio file formats may be used for background music and sound effects. HTML, CSS and JavaScript, and other web-based file formats may be used for interactive components of the media content. Media asset may also include one or more streaming channels. Media features may refer to capabilities that the media entities provide as services such as Bluetooth connectivity, resolution level selectivity, downloadability on local devices, compatibility with a particular operating system or software on local devices, etc.

According to some embodiments, the intelligent asset management system may utilize an artificial intelligence (AI) model. In some examples, the AI model may be embedded in and executed by a local computing device at a viewer's location or a server computing device, such as a server of the content provider. The AI model may analyze the logs, such as error logs generated by user devices, and automatically identify patterns or correlations. Historic problematic assets, which creates failures in playback of the media content, may contain features or data that caused instability, crashes, or malfunctioning while media content is being played. The error logs may include information related to a media content identifier and a timestamp recorded when the errors occurred. Subsequent problematic assets may be identified by analyzing image files, audio files, metadata, uniform resource locator (URL), video segment files, etc., and identifying similar patterns or correlations in the data as those identified in the error logs for the historic problematic assets. Once the subsequent problematic assets are identified, such assets or features may be removed from the original media content. In some examples, the entire media content may be removed from the server such that user does not experience any interruptions while viewing the media content.

Based on the severity or recurrence of failures or crashes, the system may intelligently determine whether to remove the assets, features, or media content from the server or send notifications to the user without removing the media content from the server. For example, if the system determines that the above failures only pertain to a specific operation, the system may determine to only send notifications to users. If the users receive such notifications, the users may be instructed to take further action, such as to reload a streaming platform, re-launch the asset for playback, remove the media content from the local device, etc. In the above situation, the system does not need to remove the media content from the server, thereby reducing the overall impact on a larger population of users who do not use the same operation system and preserving resources and overhead associated with the removal and reproduction of the media content at the server level.

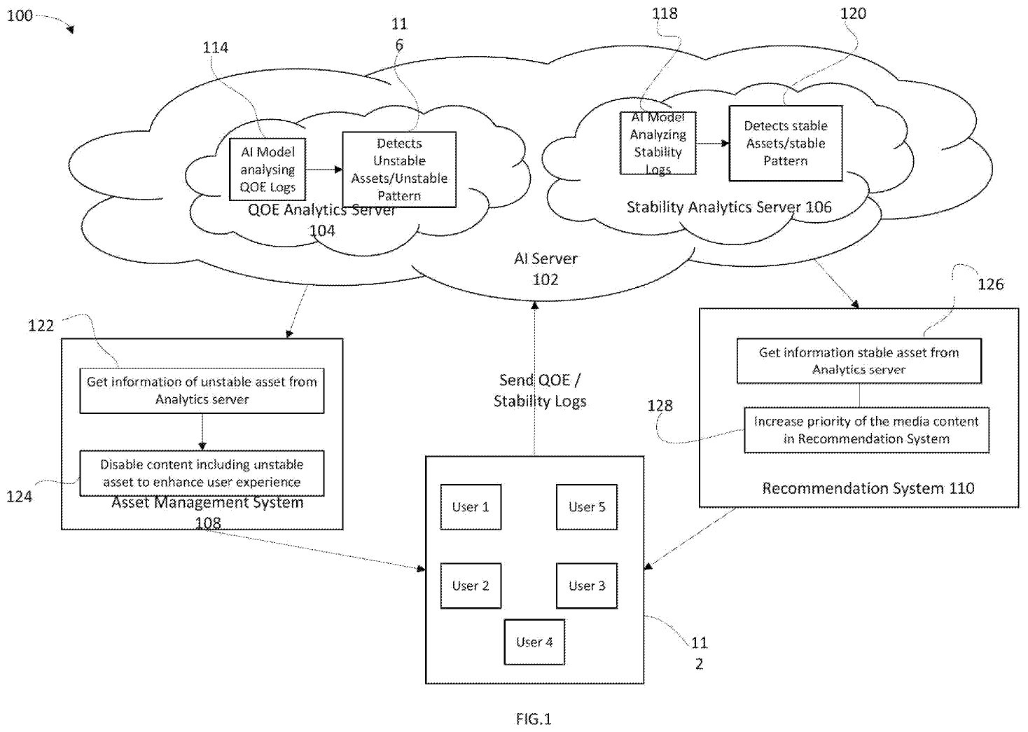

FIG. 1 depicts a block diagram illustrating an example of problematic media asset/content removal process on the server side. The adaptive asset management environment 100 may include user group 112, asset management system 108, recommendation system 110, and AI server 102. AI server 102 may include QOE analytics server 104 and stability analytics server 106. User group 112 may include users 1-5. Although there are only users 1-5 depicted in FIG. 1, it is to be understood that user group 112 may include any numbers of users. User group 112 may send a plurality of logs, such as stability logs, to AI server 102. Such logs may be manually sent by each user or automatically sent by the user's devices. Stability logs may contain a record of all the requests made to the server, including requests that were successfully served. For example, stability logs may indicate whether a particular media content was viewed by a user without encountering instability or downtime. Stability logs may be automatically transmitted to AI server 102 by the user devices when the user accesses or views the media content. Stability logs may be used to determine stable patterns of data used for media assets and/or features.

A1 server 102 may receive both QOE logs and stability logs and use a machine learning model to analyze the QOE logs at block 114 and stability logs at block 118. At block 116, QOE analytics server 104 may detect unstable media assets or patterns associated with the unstable media assets.

At block 118, in analyzing the logs, the stability analytics server 106 may detect unstable media assets and stable patterns at block 120. Stability analytic server 106 may compare the stability logs with historical data. Stability analytics server 106 may determine that a particular media content does not contain any unstable media assets based on the historical data and the recently received stability logs. Stability analytic server 106 may send information related to the stable assets to recommendation system 110.

Recommendation system 110 may discern stable assets based on the information received from stability analytics server 106 at block 126 and increase the priority of the media content containing the stable assets using the recommendation system at block 128. Recommendation system 110 may send the prioritized media content to use group 112. For example, recommendation system 110 may increase the media content's rankings in the search results or add an annotation indicating the level of reliability of the data streaming (e.g. no crashes, downtime issues in the past, etc.).

QOE analytics server 104 may send unstable media assets or patterns to asset management system 108. Asset management system 108 may receive information about the unstable media assets or patterns at block 122. Asset management system 108 may remove the media content containing the unstable media assets to enhance end-user viewing experiences according to block 124. Asset management system 108 may also delete or remove the media content containing the unstable media assets from the server and send recommendations for alternative media content to user group 112.

According to some examples, AI server 102 may stream a plurality of streaming channels to the devices of the user group 112. If one of the pluralities of streaming channels contains a problematic channel or malfunctioning features, such a channel may be removed or discontinued from the server. The channels may be affected by faulty data within media assets such as image files, metadata, URL, video segments or media features such as video-related features such as video's resolution levels. If the above channels are removed from the server, entire users of user group 112 may not access the channels.

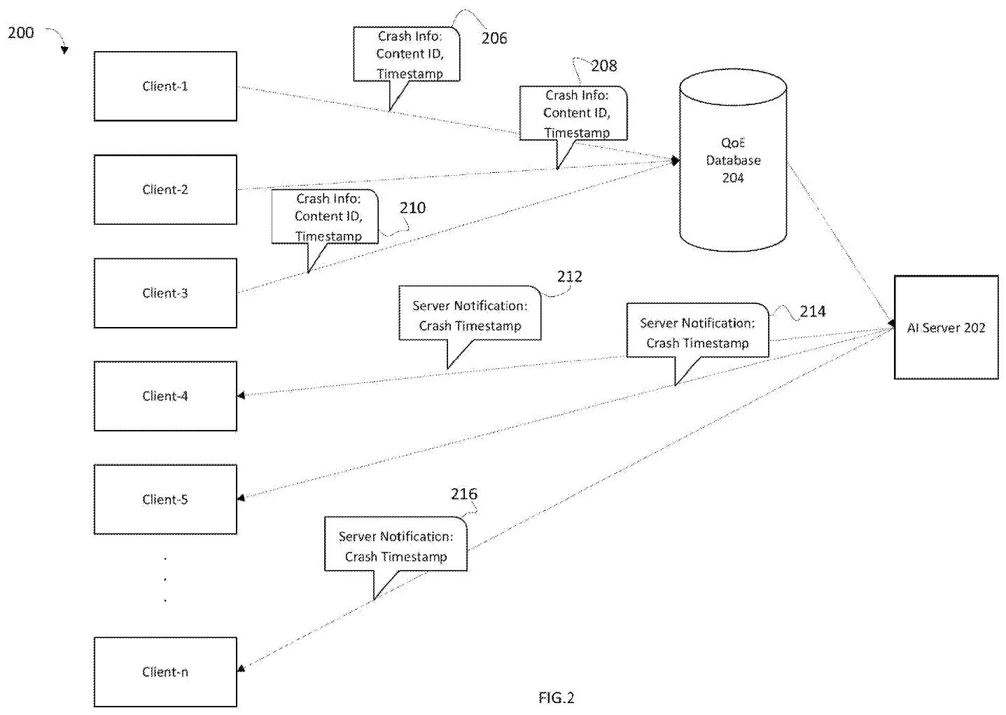

FIG. 2 depicts a block diagram illustrating a faulty asset removal on the client side. The adaptive asset management environment 200 may comprise clients 1-n, QOE database 204, and AI server 202. Clients 1-n may include individual users' electronic devices such as a laptop, tablet, smartphone, smartwatch, wearables, and/or any type of personal electronic device that may be configured to load various types of media assets. Client 1 may send log 206 to QOE database 204. Client-2 may send log 208 and client-2 may send log 210 to QOE database 204. Logs 206-208 may include information rated to crash information, affected files or media content, and timestamps recorded when the crash occurred. For example, users of clients 1-3 were viewing identical streaming content on the smartphone or tablet running using the same type of operating system (OS). When each of the users of clients 1-3 experience a crash while viewing the content at slightly different times, each of clients 1-3 may automatically send respective logs to QOE database 204. AI server 202 may receive the information from QOE database 204 and analyze the information to identify any unstable media assets or patterns. For example, AI server 202 may determine that the crashed or faulty media asset is only detected on the devices using a particular operating system. AI server 202 may send notifications to client 4-n with the information that certain media content contains the faulty media asset. AI server 202 may also record a specific timestamp of the faulty portion of the media content such that clients 4-n may skip such portions.

According to some examples, the adaptive asset management system may utilize machine learning techniques to automatically identify and determine whether the media content containing problematic media assets needs to be removed from the server's database or notifications need to be sent to the clients instead of removing the media content entirely from the server's database. In other examples, the problematic asset may be modified at the server level and the server's database may be updated with the modified media asset. The user may be notified of the modification. Server 202 may assess patterns or failures and dynamically disable or adjust the problematic media assets based on the severity and recurrence rates of the failure. If the potential impact is not assessed to be greater than a threshold level, the AI server may determine to notify the clients of the problematic portion of the content or portions that are affected by the problematic media assets such that the clients may avoid and skip the portion affected by the problematic media assets on their own, such as by manual input commands controlling playback of the content.

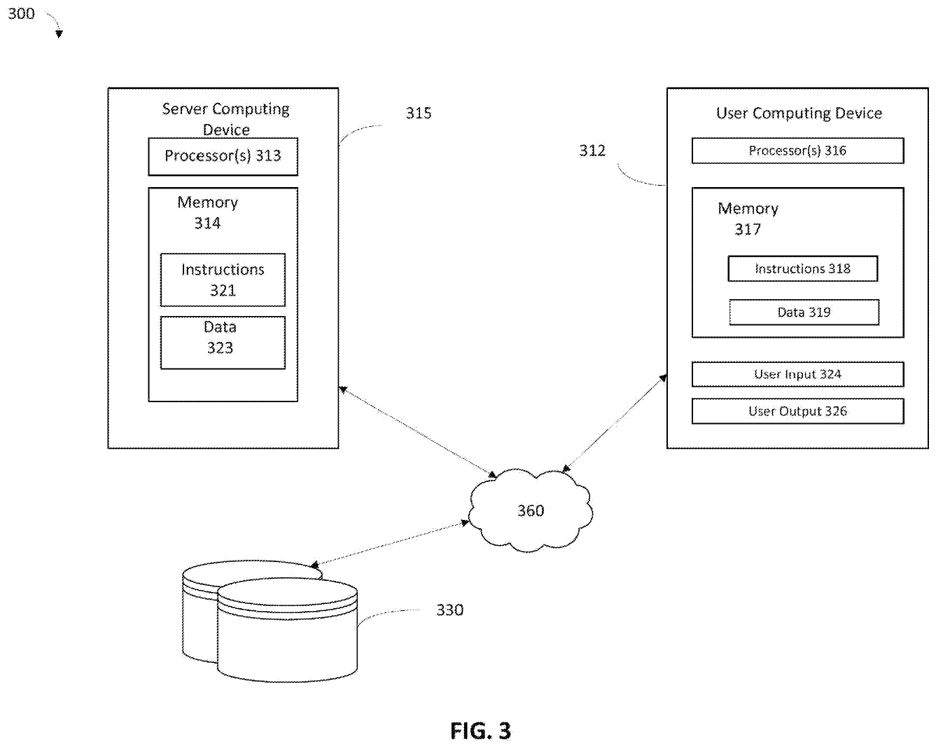

FIG. 3 depicts a block diagram illustrating an example intelligent asset management system. User computing device 312 and the server computing device 315 can be communicatively coupled to one or more storage devices 330 over a network 360. The storage device(s) 330 can be a combination of volatile and non-volatile memory and can be at the same or different physical locations than the computing devices 312, 315. For example, the storage device(s) 330 can include any type of non-transitory computer-readable medium capable of storing information, such as a hard-drive, solid state drive, tape drive, optical storage, memory card, ROM, RAM, DVD, CD-ROM, write-capable, and read-only memories.

The server computing device 315 can include one or more processors 313 and memory 314. Memory 314 can store information accessible by the processor(s) 313, including instructions 321 that can be executed by the processor(s) 313. Memory 314 can also include data 323 that can be retrieved, manipulated, or stored by the processor(s) 313. Memory 314 can be a type of non-transitory computer-readable medium capable of storing information accessible by the processor(s) 313, such as volatile and non-volatile memory. The processor(s) 313 can include one or more central processing units (CPUs), graphic processing units (GPUs), field-programmable gate arrays (FPGAs), and/or application-specific integrated circuits (ASICs), such as tensor processing units (TPUs).

Instructions 321 can include one or more instructions that when executed by the processor(s) 313, cause the one or more processors to perform actions defined by the instructions. Instructions 321 can be stored in object code format for direct processing by the processor(s) 313, or in other formats including interpretable scripts or collections of independent source code modules that are interpreted on demand or compiled in advance. Instructions 321 can include instructions for implementing processes consistent with aspects of this disclosure. For example, instruction 321 may include removing media contents containing problematic media assets based on AI model's analysis. Such processes can be executed using the processor(s) 313, and/or using other processors remotely located from the server computing device 315.

The data 323 can be retrieved, stored, or modified by the processor(s) 313 in accordance with instructions 321. Data 323 can be stored in computer registers, in a relational or non-relational database as a table having a plurality of different fields and records, or as JSON, YAML, proto, or XML documents. Data 323 can also be formatted in a computer-readable format such as, but not limited to, binary values, ASCII, or Unicode. Moreover, data 323 can include information sufficient to identify relevant information, such as numbers, descriptive text, proprietary codes, pointers, references to data stored in other memories, including other network locations, or information that is used by a function to calculate relevant data. For example, data 323 may include QOE logs and stability logs received from user groups 112 in FIG. 1.

User computing device 312 can also be configured similar to the server computing device 315, with one or more processors 316, memory 317, instructions 318, and data 319. The user computing device 312 can also include a user output 326, and a user input 324. The user input 324 can include any appropriate mechanism or technique for receiving input from a user, such as keyboard, mouse, mechanical actuators, soft actuators, touchscreens, microphones, and sensors.

Server computing device 315 can be configured to transmit data to the user computing device 312, and the user computing device 312 can be configured to display at least a portion of the received data on a display implemented as part of the user output 326. The user output 326 can also be used for displaying an interface between the user computing device 312 and the server computing device 315. The user output 326 can alternatively or additionally include one or more speakers, transducers or other audio outputs, a haptic interface or other tactile feedback that provides non-visual and non-audible information to the platform user of the user computing device 312.

Although FIG. 3 illustrates the processors 313, 316 and the memories 314, 317 as being within the computing devices 315, 312, components described in this specification, including the processors 313, 316 and the memories 314, 317 can include multiple processors and memories that can operate in different physical locations and not within the same computing device. For example, some of the instructions 321, 318 and the data 323, 319 can be stored on a removable SD card and others within a read-only computer chip. Some or all of the instructions and data can be stored in a location physically remote from, yet still accessible by, the processors 313, 316. Similarly, processors 313, 316 can include a collection of processors that can perform concurrent and/or sequential operations. Computing devices 315, 312 can each include one or more internal clocks providing timing information, which can be used for time measurement for operations and programs run by computing devices 315, 312.

The server computing device 315 can be configured to receive requests to process data from the user computing device 312. For example, environment 300 can be part of a computing platform configured to provide a variety of services to users, through various user interfaces and/or APIs exposing the platform services. One or more services may be analyzing and determining stable/unstable patterns from QOE logs. The user computing device 312 may receive and transmit data related to crash logs, QOE, and other types of error logs, etc.

Devices 312, 315 can be capable of direct and indirect communication over network 360. Devices 312, 315 can set up listening sockets that may accept an initiating connection for sending and receiving information. The network 360 itself can include various configurations and protocols including the Internet, World Wide Web, intranets, virtual private networks, wide area networks, local networks, and private networks using communication protocols proprietary to one or more companies. Network 360 can support a variety of short- and long-range connections. The network 360, in addition, or alternatively, can also support wired connections between devices 312, 315, including over various types of Ethernet connection.

Although a single server computing device 315 and user computing device 312 are shown in FIG. 3, it is understood that the aspects of the disclosure can be implemented according to a variety of different configurations and quantities of computing devices, including in paradigms for sequential or parallel processing, or over a distributed network of multiple devices. In some implementations, aspects of the disclosure can be performed on a single device, and any combination thereof.

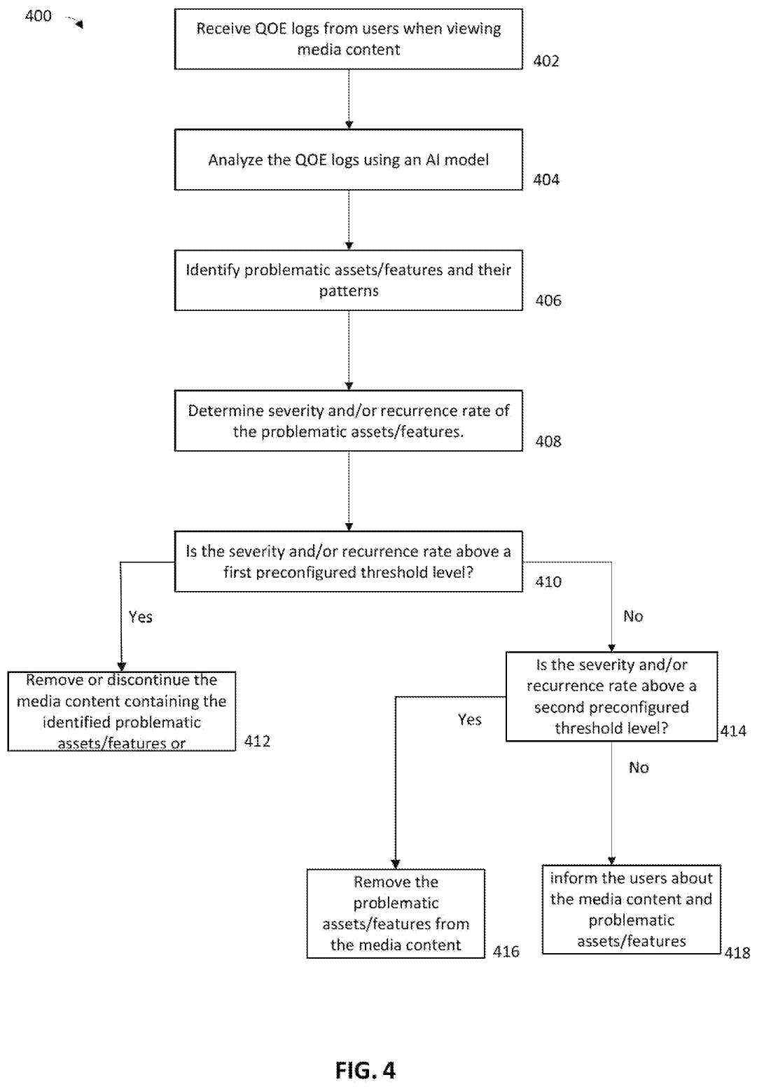

FIG. 4 depicts a flow diagram illustrating an example faulty asset removal process according to aspects of the disclosure. According to block 402, the adaptive asset management system may receive QOE logs from users who are viewing the media content. User devices may send logs whenever crashes happen when users are viewing a television program, movie, sports game or podcast on the user devices.

According to block 404, the adaptive asset management system may analyze the QOE logs using an AI model. Based on the analysis, the data within media assets causing the failures or crashes may be identified and recorded into a centralized server. The server may compare the identified data with the historical data set that caused similar types of failures. The adaptive asset management system may also determine whether fixing the above failures may take longer than a predetermined time threshold.

According to block 406, the adaptive asset management system may identify problematic assets and their patterns. Based on the determined patterns, the adaptive asset management system may assess whether other images, metadata, play URLs, and video segments will likely have similar problems in the near future.

According to block 408, the severity and/or recurrence rate of the problematic assets or features may be determined. The severity of the problematic assets or features may be determined based on the anticipated time to repair the problematic assets or features. In some other examples, the severity of the problematic assets may be determined based on whether the media content containing the problematic assets or features may still be played and viewed by a user without interruption or downtime. For example, if the feature related to closed captioning is malfunctioning, the viewer may still decide to continue viewing the media content without the closed captioning. However, if the sound of the media content does not play correctly, the viewer may decide to discontinue viewing the media content. In such a case, the system may decide to temporarily remove the entire media content. The adaptive asset management system may determine the recurrence rate of similar problematic assets or features based on the QOEs and predicted patterns from the past.

According to block 410, the adaptive asset management system may determine whether the severity and/or recurrence rate is above the first preconfigured threshold level. If the severity and/or recurrence rate is above the first preconfigured threshold level, then the process 400 may proceed to block 412. If the severity and/or recurrence rate is below the first preconfigured threshold level, the process 400 may proceed to block 414.

According to block 412, the adaptive asset management system may remove or discontinue the media content containing the identified problematic assets or features. For example, the adaptive asset management system may determine to remove entire content of the first episode of a TV series if the first episode contains the problematic assets or features with the severity and/or recurrence rate above the preconfigured threshold level. The adaptive asset management system may temporarily remove the media content such that the problematic assets or features may be repaired. The media content may be proactively removed such that viewers do not experience any downtime or crash while watching the particular media content.

According to block 414, when the severity and/or recurrence rate is below the first preconfigured threshold level, the adaptive asset management system may determine whether the severity and/or recurrence rate is above the second preconfigured threshold level. If the severity and/or recurrence rate is above the second preconfigured threshold level, process 400 may proceed to block 416. If the severity and/or recurrence rate is below the second preconfigured threshold level, process 400 may proceed to block 418.

According to block 416, the adaptive asset management system may remove problematic assets or features from the media content. For example, if the closed captioning is malfunctioning, then the adaptive asset management system may remove the closed captioning feature from the media content. Even if the closed captioning feature is removed, the viewers may continue to watch the media content without the closed captioning. In another example, if the metadata about the media content is corrupted and cannot be retrieved by the adaptive asset management system, the adaptive asset management system may remove the metadata from the media content. The viewer may continue to view the media content without the metadata.

According to block 418, the adaptive asset management system may only notify the viewers of the problematic assets or features. For example, if the media content cannot be played in HD resolution, the adaptive asset management system may notify the viewers that the media content can still be viewed in other levels of resolutions. The viewers may or may not choose to view the media content in a different resolution. The viewers may not need to encounter problems while viewing the media content since the viewers were notified in advance.

Enhanced capabilities of the media system allow for confirming patterns of problematic assets or feature and automatically determining whether to remove the entire media content, remove only the problematic assets or features or selectively notifying the viewers that may be affected by the predicted problematic assets or features. By selectively removing only the problematic assets or features or notifying the selected viewers that may be affected with the problematic assets or feature, the overhead associated with the removal, repair or reproduction of the media content at the server level can be preserved.

Aspects of this disclosure can be implemented in digital circuits, computer-readable storage media, as one or more computer programs, or a combination of one or more of the foregoing. The computer-readable storage media can be non-transitory, e.g., as one or more instructions executable by a cloud computing platform and stored on a tangible storage device.

In this specification the phrase “configured to” is used in different contexts related to computer systems, hardware, or part of a computer program, engine, or module. When a system is said to be configured to perform one or more operations, this means that the system has appropriate software, firmware, and/or hardware installed on the system that, when in operation, causes the system to perform the one or more operations. When some hardware is said to be configured to perform one or more operations, this means that the hardware includes one or more circuits that, when in operation, receive input and generate output according to the input and corresponding to the one or more operations. When a computer program, engine, or module is said to be configured to perform one or more operations, this means that the computer program includes one or more program instructions, that when executed by one or more computers, causes the one or more computers to perform the one or more operations.

Although the technology herein has been described with reference to particular examples, it is to be understood that these examples are merely illustrative of the principles and applications of the present technology. It is therefore to be understood that numerous modifications may be made and that other arrangements may be devised without departing from the spirit and scope of the present technology as defined by the appended claims.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible implementations. Further, the same reference numbers in different drawings can identify the same or similar elements.

1. A computer-implemented method for adaptive media content management, the method comprising:
receiving, by one or more processors, error logs from a plurality of user devices, wherein the error logs were generated in relation to a playback of a first set of media content;
analyzing, by the one or more processors executing an artificial intelligence model, the received error logs;
determining, by the one or more processors, one or more patterns of problematic data from the error logs;
determining potential problems associated with a second set of media content based on the one or more patterns;
identifying assets or features corresponding to the potential problems associated with the second set of media content; and
removing the assets or features corresponding to the potential problems from the media content.

2. The method of claim 1, wherein the error logs are generated when crashes, instability, or malfunctioning occurs.

3. The method of claim 1, further comprising modifying the assets or features corresponding to the potential problems.

4. The method of claim 1, further comprising determining one or more stable patterns of data within the assets or features.

5. The method of claim 4, further comprising increasing a priority of the media content containing the stable patterns of data using a media content recommendation system.

6. The method of claim 1, further comprising notifying viewers of the second set of media content of the potential problems.

7. The method of claim 1, wherein the error logs include information related to a content identifier of the media content and a timestamp recorded when one or more errors occurred.

8. A system for adaptive media content management, the system comprising:
memory; and
one or more processors configured to:
receive error logs from a plurality of user devices, wherein the error logs were generated in relation to a playback of a first set of media content;
analyze, using an artificial intelligence model, the received error logs;
determine one or more patterns of problematic data from the error logs;
determine potential problems associated with a second set of media content based on the one or more patterns;
identify assets or features corresponding to the potential problems associated with the second set of media content; and
remove the assets or features corresponding to the potential problems from the media content.

9. The system of claim 8, wherein the error logs are generated when crashes, instability, or malfunctioning occurs.

10. The system of claim 8, wherein the one or more processors are further configured to modify the assets or features corresponding to the potential problems.

11. The system of claim 8, wherein the one or more processors are further configured to determine one or more stable patterns of data within the assets or features.

12. The system of claim 11, wherein the one or more processors are further configured to increase a priority of the media content containing the stable patterns of data using a media content recommendation system.

13. The system of claim 8, wherein the one or more processors are further configured to notify viewers of the second set of media content of the potential problems.

14. The system of claim 8, wherein the error logs include information related to a content identifier of the media content and a timestamp recorded when one or more errors occurred.

15. A non-transitory computer-readable medium storing instructions executable by one or more processors for performing a method of adaptive media content management, the method comprising:
receiving error logs from a plurality of user devices, wherein the error logs were generated in relation to a playback of a first set of media content;
analyzing, using an artificial intelligence model, the received error logs;
determining one or more patterns of problematic data from the error logs;
determining potential problems associated with a second set of media content based on the one or more patterns;
identifying assets or features corresponding to the potential problems associated with the second set of media content; and
removing the assets or features corresponding to the potential problems from the media content.

16. The non-transitory computer-readable medium of claim 15, wherein the error logs are generated when crashes, instability, or malfunctioning occurs.

17. The non-transitory computer-readable medium of claim 15, wherein the method further comprises modifying the assets or features corresponding to the potential problems.

18. The non-transitory computer-readable medium of claim 15, wherein the method further comprises determining one or more stable patterns of data within the assets or features.

19. The non-transitory computer-readable medium of claim 15, wherein the method further comprises increasing a priority of the media content containing the stable patterns of data using a media content recommendation system.

20. The non-transitory computer-readable medium of claim 15, wherein the method further comprises notifying viewers of the second set of media content of the potential problems.
